(19) United States
(12) Patent Application Publication
(10) Pub. No.: US 2023/0382158 A1
(43) Pub. Date: Nov. 30, 2023

(54) Cover Element Suitable for Attachment to a Vehicle Wheel

(71) Applicant: Bayerische Motoren Werke Aktiengesellschaft, Muenchen (DE)

(72) Inventors: Stella CLARKE, Garching (DE); Benedikt FELLA, Muenchen (DE); Mike SEIDEL, Schoeneck (DE); Claudio STRUCKMANN, Muenchen (DE)

(21) Appl. No.: 18/031,934

(22) PCT Filed: Oct. 12, 2021
(86) PCT No.: PCT/EP2021/078158

§ 371 Date: Apr. 14, 2023

(30) Foreign Application Priority Data
Oct. 15, 2020 (DE) 10 2020 127 174.3

(51) Int. Cl. B60B 7/06; B60B 7/00; B60B 7/02

(52) U.S. Cl. CPC B60B 7/066; B60B 7/0033; B60B 7/02

(57) ABSTRACT

A cover element is suitable for attachment to a vehicle wheel having a hub, a wheel rim provided with a rim well for accommodating a tire, and wheel spokes which connect the hub to the wheel rim. The cover element is designed to cover at least one gap between two wheel spokes that adjoin one another in the circumferential direction. The outer surface of the cover element, at least in regions, is provided with at least one bistable display element, such as an e-paper display element having a display device, or is formed by at least one such element, wherein the display device can be supplied with electrical control signals via a control unit.

### TECHNICAL FIELD

The invention relates to a cover element adapted for attachment to a vehicle wheel. It also relates to a vehicle wheel having at least one such cover element, and to vehicle having at least one such vehicle wheel.

### BACKGROUND AND SUMMARY

Particularly in the case of electric vehicles, closed wheels, in which the interspaces between the wheel spokes are covered or at least partially closed, are used for aerodynamic reasons. Plastic covers that are glued, clipped or screwed into the metallic main body of the vehicle wheel are usually used for this purpose. For design reasons, these plastic covers may be painted or colored in different colors. If vehicle users wish to change the design of the wheels on their vehicle, they must purchase a new set of covers and replace the existing set in the wheels with the new covers of a different color. This is costly and considerably limits the flexibility of the color design.

EP 3 153 328 B1 discloses and describes a turbine insert for a vehicle wheel, which is provided with two aerodynamic blades and which can be inserted into an opening in a wheel main body, between two adjacent wheel spokes.

Known from DE 10 2018 203 805 A1 is a vehicle wheel in which at least one interspace between the wheel spokes is at least partially covered by a cover element comprising a wing portion, the cover element being mountable onto the wheel from an outer side of the wheel.

DE 10 2011 102 680 A1 discloses a vehicle wheel having a hub cover provided with a display device.

The object of the present invention is to improve upon a generic cover element in such a way that it can be used more flexibly.

This object is achieved with the features of the independent claims.

A cover element according to the invention is adapted for attachment to a vehicle wheel having a wheel hub, a wheel rim provided with a rim base for receiving a tire, and wheel spokes connecting the wheel hub to the wheel rim, wherein the cover element is designed to cover at least one interspace between two circumferentially mutually adjacent wheel spokes. It is characterized in that the outer surface of the cover element, at least in regions, is provided with or formed by at least one bistable display element, preferably an e-paper display element, comprising a display device to which electric control signals can be applied via a control unit.

Equipping the outer surface of the cover element, at least in regions, with at least one e-paper display element makes it possible to individually design and alter the design (color and/or graphics) represented on the display device of the at least one e-paper display element without the need to replace or even repaint the cover element. The use of an e-paper display element has the advantage that electrical energy only needs to be available for the design change. Once the design has been changed, the new state remains stable without electrical power.

Further preferred and advantageous design features of the cover element according to the invention are provided by the dependent claims.

Preferably, the display device of the at least one e-paper display element covers the outer surface, at least in regions. This makes it possible to influence the design over a large area.

It is also advantageous if the at least one e-paper display element is designed to represent color displays on the display device. This variant makes it possible not only to design black and white graphics, but also to display colored designs.

In the case of a preferred development of the invention, which can be combined with other embodiments of the invention, the control unit is equipped with or connected to a selecting or input device, by means of which a user can select or set colors and/or patterns to be displayed on the display device of the e-paper display element, the control unit being designed to thereupon generate corresponding display signals and transmit them to the e-paper display element. This variant allows the vehicle wheel to be designed in a particularly flexible and individualized manner.

It is advantageous in this case if the control unit is designed to set the color displayed by the e-paper display element so as to be alterable. This embodiment of the invention allows the user to display any color and/or color gradients.

In the case of a further preferred design of the invention, which likewise can be combined with other embodiments of the invention, the outer surface of the cover element is provided, at least in regions, with at least one solar element for generating an electrical power supply for the at least one e-paper display element. This variant makes the cover element electrically independent of the vehicle electrical power system.

In the case of yet another preferred design of the invention, which can also be combined with other embodiments of the invention, at least one receiving coil of an inductive electrical power transmission device is provided, via which an electrical power supply for the at least one e-paper display element can be transmitted wirelessly from an external electrical power source, preferably from a vehicle electrical system. The receiving coil is preferably provided on the inner surface (facing toward the vehicle) of the cover element that faces away from the outer surface.

The invention additionally concerns a vehicle wheel having a wheel hub, a wheel rim provided with a rim base for receiving a tire, and wheel spokes connecting the wheel hub to the wheel rim, and having at least one cover element according to an embodiment of the invention, wherein the cover element covers at least one interspace between two circumferentially mutually adjacent wheel spokes.

Furthermore, the invention also relates to a motor vehicle having at least one such vehicle wheel.

Preferred exemplary embodiments of the invention with additional design details and further advantages are described and explained in more detail below with reference to the accompanying drawing.

### BRIEF DESCRIPTION OF THE DRAWINGS

FIG. 1 is a side view of the front left part of motor vehicle equipped with a vehicle wheel realized according to an embodiment of the invention;

FIG. 2 is a side view of the vehicle from FIG. 1 with a cover element represented in partial section; and

FIG. 3 is a schematic cross-section through an e-paper display element.

### PRESENTATION OF PREFERRED EXEMPLARY EMBODIMENTS

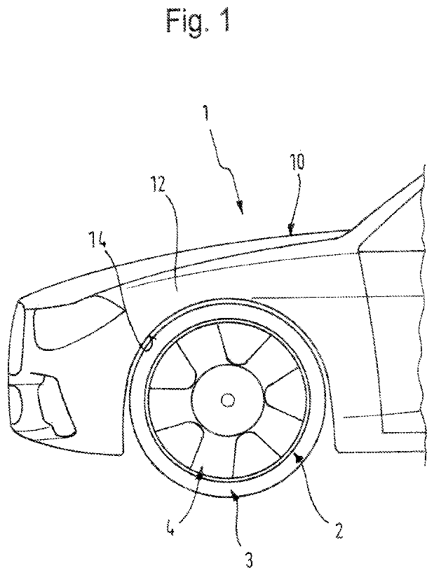

FIG. 1 shows the front left side of a motor vehicle 1 having a vehicle body 10, which has a front left wheel arch 14 in a front left fender 12. The wheel arch 14 accommodates a left front vehicle wheel 2, which in a conventional manner is mounted on a structure of the motor vehicle 1 so as to be rotatable and steerable.

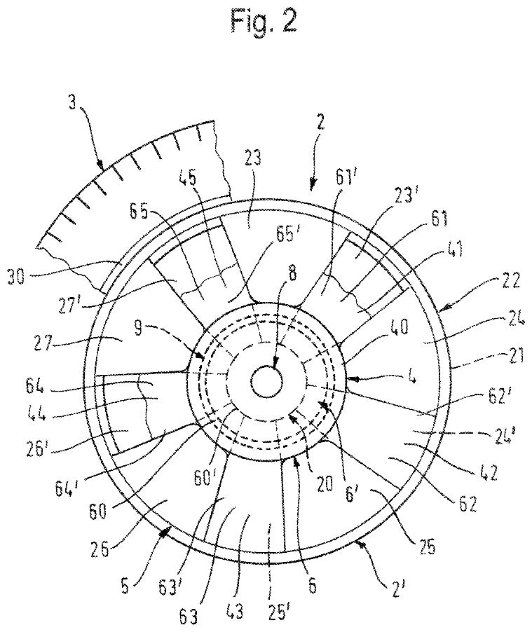

The vehicle wheel 2 provided with a tire 3 is represented in detail in FIG. 2.

The vehicle wheel 2 has a wheel hub 20, a wheel rim 22, and wheel spokes 23, 24, 25, 26, 27 that extend radially between the wheel hub 20 and the wheel rim 22 and connect these to one another. On its radially outer side the wheel rim 22 is in a conventional manner provided with a rim base 21, in which the tire 3 is accommodated via its tire beads 30.

Realized in each case between two adjacent wheel spokes 23, 24, 25, 26, 27 there is an open interspace 23′, 24′, 25′, 26′, 27′. A cover element 4 is fitted from the outside of the vehicle onto the metallic main body 2′ of the vehicle wheel 2, which comprises the wheel hub 20, the wheel rim 22 and the wheel spokes 23, 24, 25, 26, 27. The cover element 4 covers the wheel hub 20 and a radially inner region of the wheel spokes 23, 24, 25, 26, 27 with a central circular disk 40, and has wing portions 41, 42, 43, 44, 45 extending radially outward from the circular disk 40, each of which covers one of the interspaces 23′, 24′, 25′, 26′, 27′ between two circumferentially mutually adjacent wheel spokes 23, 24, 25, 26, 27. The cover element 4, together with the surfaces of the wheel spokes 23, 24, 25, 26, 27 that face toward the outside of the vehicle, thus realizes a closed wheel disk surface 5 radially inside the wheel rim 22.

However, the invention is not limited to such a closed wheel disk, but rather the respective interspaces 23′, 24′, 25′, 26′, 27′ may also be only partially closed by the cover element 4, so as to allow air to flow between the outside of the wheel and the inside of the wheel, for example for the purpose of cooling brakes or wheel hub motors.

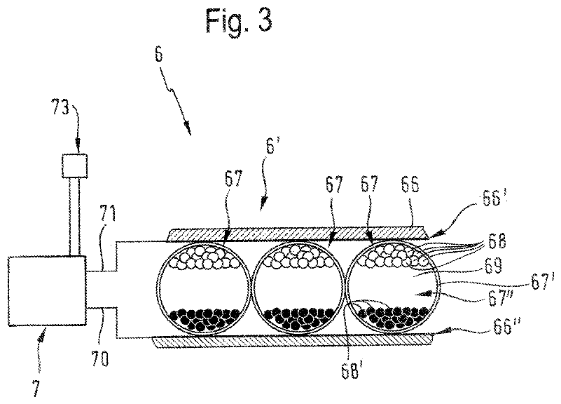

The outer surface of the cover element 4 that faces away from the vehicle is provided with at least one e-paper display element 6 in the region of the central circular disk and the radial wings 41, 42, 43, 44, 45. This e-paper display element 6 may also be provided only partially, for example as a central display element 60 only in the central circular disk 40, or corresponding e-paper display elements 61, 62, 63, 64, 65 may be provided on the outer surface of each radial wing 41, 42, 43, 44, 45. Each of the e-paper display elements 6, 60, 61, 62, 63, 64, 65 is provided with a display device 6′, 60′, 61′, 62′, 63′, 64′, 65′ that faces toward the outside of the vehicle, this being explained in more detail in connection with FIG. 3.

As represented schematically in FIG. 2, the cover element 4 may be provided—as here in the center of the cover element 4—with at least one solar element 8 that delivers an electrical power supply for the e-paper display element 6, 60, 61, 62, 63, 64, 65. Clearly, the electrical power supplied by the solar element 8 may be stored temporarily in a storage battery (not shown). Alternatively or additionally, there may be at least one receiving coil 9 of an inductive electrical power transmission device, not represented in more detail, provided on the inner surface that faces away from the outer surface of the cover element 4. In this way, an electrical power supply for the e-paper display element 4 delivered by the vehicle electrical system may be transmitted wirelessly to the receiving coil 9, and thus to the display element 6, 60, 61, 62, 63, 64, 65, by means of a transmitting coil (not shown).

As can be seen in FIG. 3, the e-paper display element 6 is provided with a display 6′ that has a transparent or translucent upper display window 66, behind which there are a multiplicity of display spheres 67 in the form of microcapsules. The display window 66 simultaneously forms a first flat (upper) electrode 66′. A second flat (lower) electrode 66″ is provided on the rear side of the e-paper display element 6, behind the display spheres 67. Each of the display spheres 67 has a transparent housing wall 67′ enclosing an interior space 67″ of the display sphere 67. The interior space 67″ contains a plurality of first pigments 68 of a first color (in this case, white) and a plurality of second pigments 68′ of a second color (in this case, black) surrounded by a transparent fluid 69, the black pigments 68′ typically being positively charged and the white pigments 68 being negatively charged.

Upon activation of a positive or negative electric field by application of a voltage to the electrodes 66′, 66″, the black pigments 68′ and the white pigments 68 move to the respectively opposite electrodes 66′, 66″. The quantity of pigment particles migrating to the upper (transparent) electrode 66′ becomes visible to the viewer as a black or white dot, respectively, in the display window 66.

This simple e-paper display element 6, shown by way of example in FIG. 3, is only capable of displaying black and white representations. Colors can also be displayed by use of a plurality of different display spheres containing colored pigments in place of the white pigments 68.

The display 6′ of the display element 6 can be supplied with electrical control signals via a control unit 7.

For this purpose, the display 6′ is functionally connected to the control unit 7 for the purpose of signal transmission. In FIG. 3, this connection is represented by electrical signal lines 70, 71, which is the case if the control unit 7 is provided on the display element 6. Alternatively, however, this connection may also be wireless.

The control unit 7 is equipped with or preferably wirelessly connected to a selecting or input device 73. By means of the selecting and input device 73, a user can select or set the colors and/or patterns to be displayed on the display 6′, 60′, 61′, 62′, 63′, 64′, 65′, whereupon the control unit 7 generates corresponding display signals, and transmits them to the display 6′, 60′, 61′, 62′, 63′, 64′, 65′, and the display 6′ 60′, 61′, 62′, 63′, 64′, 65′, displays the selected color and/or graphical pattern.

The invention is not limited to the above exemplary embodiment, which merely serves to provide a general explanation of the core concept of the invention. Rather, within the scope of protection, the device according to the invention may also assume forms of embodiment other than those described above. In this regard, the device may in particular have features that are a combination of the respective individual features of the claims.

References in the claims, the description and the drawings serve only for a better understanding of the invention and are not intended to limit the scope of protection.

### LIST OF REFERENCES

1 motor vehicle
2 vehicle wheel
2′ main body of the vehicle wheel
3 tire
4 cover element
5 wheel disk face
6 e-paper display element
6′ display device (display)
7 control unit
8 solar element
9 receiving coil
10 vehicle body
12 fender
14 wheel arch
20 wheel hub
21 rim base
22 wheel rim
23 wheel spoke
23′ interspace
24 wheel spoke
24′ interspace
25 wheel spoke
25′ interspace
26 wheel spoke
26′ interspace
27 wheel spoke
27′ interspace
30 tire bead
40 central circular disk
41 wing portion
42 wing portion
43 wing portion
44 wing portion
45 wing portion
60 e-paper display element
60′ display device
61 e-paper display element
61′ display device
62 e-paper display element
62′ display device
63 e-paper display element
63′ display device
64 e-paper display element
64′ display device
65 e-paper display element
65′ display device
66 display window
66′ electrode
66″ electrode
67 display sphere
67′ housing wall
67″ interior space of the display sphere
68 first pigment
68′ second pigment
69 fluid
70 signal line
71 signal line
73 input device

1.-9. (canceled)

10. An apparatus adapted for attachment to a vehicle wheel having a wheel hub, a wheel rim provided with a rim base for receiving a tire, and wheel spokes connecting the wheel hub to the wheel rim, comprising:
a cover element configured to cover at least one interspace between two circumferentially mutually adjacent wheel spokes;
at least one bistable display element comprising a display forming or provided on an outer surface of the cover element, at least in regions; and
a control unit by which electric control signals are applied to the display.

11. The apparatus according to claim 10, wherein
the bistable display element is an e-paper display element.

12. The apparatus according to claim 11, wherein
the display of the at least one e-paper display element covers the outer surface, at least in regions.

13. The apparatus according to claim 11, wherein
the at least one e-paper display element is configured to represent color displays on the display.

14. The apparatus according to claim 11, wherein
the control unit is equipped with or connected to a selecting or input device, by which a user can select or set colors and/or patterns to be displayed on the display of the e-paper display element, and
the control unit is configured to thereupon generate corresponding display signals and transmit them to the display.

15. The apparatus according to claim 14, wherein
the control unit is configured to set the color displayed by the e-paper display element so as to be alterable.

16. The apparatus according to claim 11, wherein
the outer surface of the cover element is provided, at least in regions, with at least one solar element for generating an electrical power supply for the at least one e-paper display element.

17. The apparatus according to claim 11, wherein
on an inner surface of the cover element that faces away from the outer surface, at least one receiving coil of an inductive electrical power transmission device is provided, via which an electrical power supply for the at least one e-paper display element is transmittable wirelessly from an external electrical power source.

18. The apparatus according to claim 17, wherein
the external electrical power source is from a vehicle electrical system.

19. A vehicle wheel, comprising:
a wheel hub;
a wheel rim provided with a rim base for receiving a tire;
wheel spokes connecting the wheel hub to the wheel rim; and
a cover element configured to cover at least one interspace between two circumferentially mutually adjacent wheel spokes;
at least one bistable display element comprising a display forming or provided on an outer surface of the cover element, at least in regions; and
a control unit by which electric control signals are applied to the display.

20. A motor vehicle comprising at least one vehicle wheel according to claim 19.
